(19) United States
(12) Patent Application Publication
(10) Pub. No.: US 2021/0336428 A1
(43) Pub. Date: Oct. 28, 2021

(54) Cable and Wire Scoring Tool for Jacket Removal

(71) Applicant: Baker Hughes Oilfield Operations LLC, Houston, TX (US)

(72) Inventor: Nicholas William Pond, Broken Arrow, OK (US)

(73) Assignee: Baker Hughes Oilfield Operations LLC, Houston, TX (US)

(21) Appl. No.: 17/243,312

(22) Filed: Apr. 28, 2021

Related U.S. Application Data
(60) Provisional application No. 63/016,958, filed on Apr. 28, 2020.

(51) Int. Cl. H02G 1/12

(52) U.S. Cl. CPC H02G 1/1234; H02G 1/1224

(57) ABSTRACT

A tool for removing of one or more outer layers of a multi-layered jacketed wire includes a base member and a top member pivotally connected to the base member. The scoring tool has a first receiver recess on a first end of the scoring tool. A first cutter extends into a first receiver recess at a distance (d₁) from an interior wall of the first receiver recess, and the first cutter is transversely oriented within the first receiver recess. A second cutter extends into a second receiver recess at a distance (d₁) from an interior wall of the second receiver recess, and the second cutter is longitudinally oriented within the second receiver recess.

### RELATED APPLICATIONS

The present application claims the benefit of U.S. Provisional Patent Application Ser. No. 63/016,958 filed Apr. 28, 2020 entitled, “Cable and Wire Scoring Tool for Jacket Removal,” the disclosure of which is herein incorporated by reference.

### FIELD OF THE INVENTION

This invention relates generally to the field of electric submersible pumping systems, and more particularly, but not by way of limitation, to a tool for precisely removing jacket and insulation layers from an electrical connector.

### BACKGROUND

Electrical submersible pumping systems include specialized electric motors that are used to power one or more high performance pump assemblies. The motor is typically an oil-filled, high capacity electric motor that can vary greatly in length and may be rated up to hundreds of horsepower. Typically, electricity is generated on the surface and supplied to the motor through a heavy-duty power cable. The power cable typically includes several separate conductors that are individually insulated within the power cable.

In many applications, power is conducted from the power cable to the motor via a separate “motor lead cable,” which has a flat or reduced profile to facilitate placement of the cable in the smaller annular space between the downhole pumping system and the well casing. The motor lead cable typically includes one or more “leads” that are configured for connection to a mating receptacle on the motor. The leads from the motor lead cable are often retained within a motor-connector that is commonly referred to as a “pothead.” The pothead relieves the stress or strain realized between the motor and the leads from the motor lead cable.

Because the power and motor lead cables are positioned in the annulus between the production string and well casing, these cables and connectors must be designed to withstand the inhospitable downhole environment. Power and motor lead cables typically include a conductor, insulation surrounding the conductor, a sheath encasing the insulation and a durable external armor that surrounds the sheath.

During manufacture, the insulation, sheathing or armor must be removed from the end of the cable to permit the conductor leads to be connected to the pothead or other electrical connection. For thicker gauged wire with tough outer jackets, it can be difficult to cut or score the outer layers without damaging the inner layers. Traditional methods include using handheld blades or wire cutters, which can produce inconsistent results. Jacketing material also tends to quickly dull scoring blades and existing handheld tools must be discarded once the scoring blade is no longer sufficiently sharp to perform the scoring function. It is to this and other deficiencies in the prior art that the present invention is directed.

### SUMMARY OF THE INVENTION

In one aspect, embodiments discloses herein include a scoring tool for facilitating the removal of one or more outer layers of a multi-layered jacketed wire. The scoring tool includes a first receiver recess on a first end of the scoring tool, where the first receiver recess is substantially cylindrical and has an interior wall and an exterior opening. The scoring tool includes a first cutter that extends into the first receiver recess at a distance (d₁) from the interior wall of the first receiver recess, wherein the first cutter is transversely oriented within the first receiver recess. The scoring tool also includes a second receiver recess on a second end of the scoring tool, where the second receiver recess is substantially cylindrical and has an interior wall and an exterior opening. A second cutter extends into the second receiver recess at a distance (d₁) from the interior wall of the second receiver recess. The second cutter is longitudinally oriented within the second receiver recess.

In another aspect, embodiment disclosed herein include a method of removing one or more layers surrounding a conductor of a jacketed wire. The method begins with the step of providing a scoring tool that includes a first receiver recess, a first cutter in the first receiver recess, a second receiver recess, and a second cutter in the second receiver recess. The method continues with the step of inserting a distal end of the jacketed wire into the first receiver recess such that an end of the jacketed wire contacts an interior wall of the first receiver recess. Next, the method includes the step of closing the scoring tool such that the first cutter is pressed into the jacketed wire at a desired depth and at a distance (d1) from the end of the jacketed wire. The method concludes with the step of inducing a rotation between the scoring tool and the jacketed wire to perform a circumscribed cut at the distance (d1) from the end of the jacketed wire.

In yet another aspect, embodiment disclosed herein include a method of removing one or more layers surrounding a conductor of a jacketed wire in which the method begins with the step of providing a scoring tool that includes a first receiver recess, a first cutter in the first receiver recess, a second receiver recess, and a second cutter in the second receiver recess. The method continues with the step of inserting the end of the jacketed wired into the second receiver recess such that the end of the jacketed wire contacts an interior wall of the second receiver recess. Next, the method includes the step of closing the scoring tool such that the second cutter is pressed into the jacketed wire at a desired depth and at a distance (d1) from the end of the jacketed wire. The method then includes the step of pulling the jacketed wire out of the second receiver recess to induce a longitudinal cut of (d1) length to the distal end of the jacketed wire.

### BRIEF DESCRIPTION OF THE DRAWINGS

FIG. 1 is a perspective view of an electric submersible pumping system constructed in accordance with a preferred embodiment.

FIG. 2 is a perspective view of a motor lead cable with the leads exposed and stripped.

FIG. 3 is a front perspective view of a cable scoring tool constructed in accordance with exemplary embodiments, shown in an open position.

FIG. 4 is a front view of the cable scoring tool of FIG. 3 in a closed position.

FIG. 5 is a rear view of the cable scoring tool of FIG. 3 in a closed position.

FIG. 6 is a top view of the cable scoring tool of FIG. 3 in a closed position.

FIG. 7 is a left side view of the cable scoring tool of FIG. 3 in a closed position.

FIG. 8 is a right side view of the cable scoring tool of FIG. 3 in a closed position.

FIG. 9 is a left side view of the cable scoring tool of FIG. 3 in an open position.

### WRITTEN DESCRIPTION

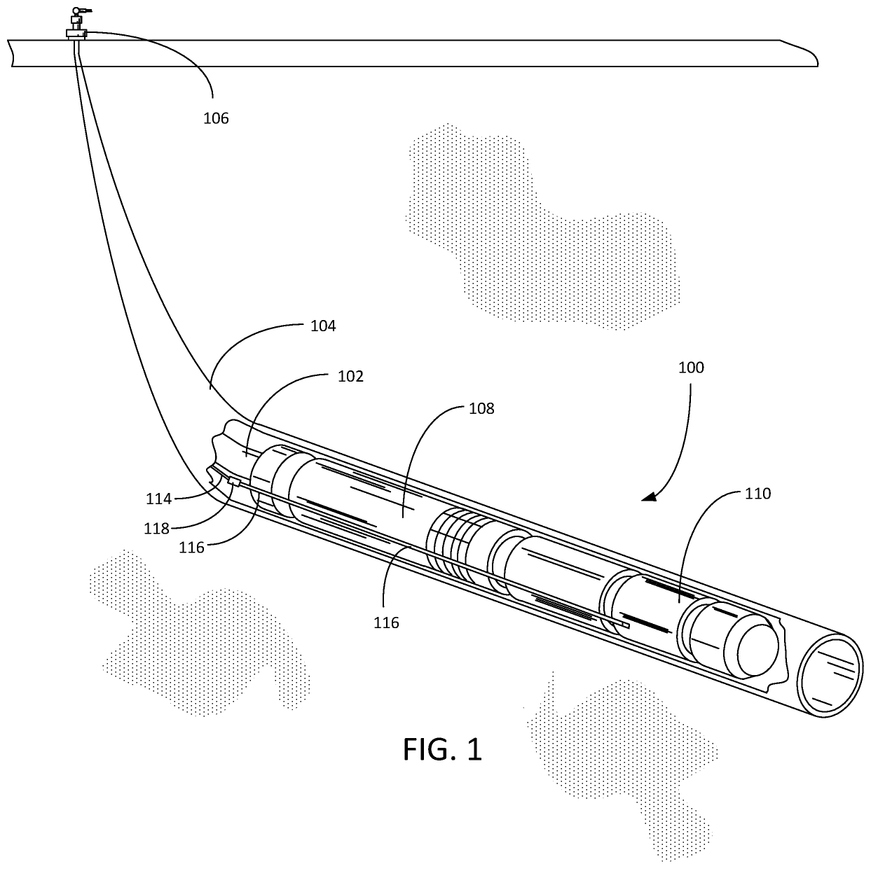

FIG. 1 shows a front perspective view of a downhole pumping system 100 attached to production tubing 102. The downhole pumping system 100 and production tubing 102 are disposed in a wellbore 104, which is drilled for the production of a fluid such as water or petroleum. The downhole pumping system 100 is shown in a non-vertical well. This type of well is often referred to as a “horizontal” well. Although the downhole pumping system 100 is depicted in a horizontal well, it will be appreciated that the downhole pumping system 100 can also be used in vertical, deviated and other non-horizontal wells.

The pumping system 100 includes a pump 108 driven by an electrical motor 110. The motor 110 converts the electrical energy into mechanical energy, which is transmitted to the pump 108 by one or more shafts. The pump 108 then transfers a portion of this mechanical energy to fluids within the wellbore, causing the wellbore fluids to move through the production tubing 102 to the surface.

The pumping system 100 includes a power cable 114, a motor lead cable 116 and a cable connector 118. The power cable 114, motor lead cable 116 and cable connector 118 cooperate to deliver electricity to the motor 110. The motor lead cable 116 includes additional armor and a low, flattened profile to more easily fit within the limited annular space between the wellbore 104 and the components of the pumping system 100. The power cable 114 can have a larger cross-section because it resides in the larger annular space between the production tubing 102 and the wellbore 104.

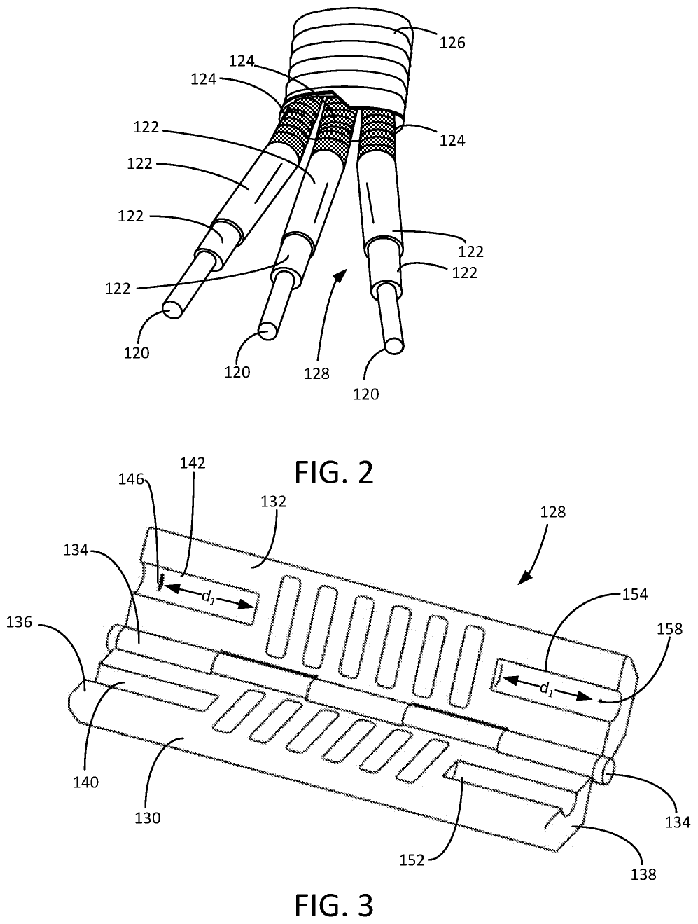

Turning to FIG. 2, shown therein is a perspective view of a representative motor lead cable 116. The motor lead cable 116 includes power cable conductors 120, inner and outer power cable insulators 122, a sheath 124 and external armor 126. The power cable conductors 120 are manufactured from copper wire or other suitable conductive metal. The power cable conductors 120 can include a solid core (as shown in FIG. 2), a stranded core or a stranded exterior surrounding a solid core. The power cable conductors 120 can also be coated with one or more layers of tin, nickel, silver, polyimide film or other suitable material. It will be understood that the size, design and composition of the power cable conductors 120 can vary depending on the requirements of the particular downhole application.

The power cable insulators 122 are optionally encased within a sheath 124. The sheath 124 can be constructed one or more layers of lead, nitrile, EPDM or thermoplastic, or some combination of these materials. The sheath 124 is protected from external contact by the armor 126. The armor 126 is manufactured from galvanized steel, stainless steel, Monel or other suitable metal or composite. As noted above, the armor 126 can be configured in flat and round profiles in accordance with the flat or round configuration of the motor lead cable 116. Unless otherwise specified, the term “jacketed wire” refers generally in this disclosure to the conductor 120 and one or more of the insulators 122 and jacket 124.

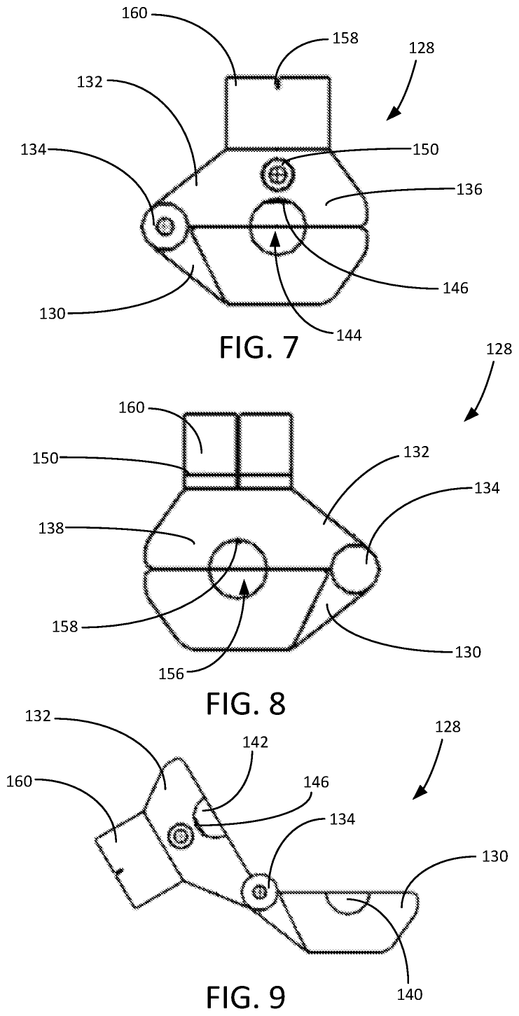

Turning to FIGS. 3-9, shown therein are various depictions of a scoring tool 128 that is configured to facilitate the removal during manufacture of one or more layers surrounding the conductors 120. The scoring tool 128 is configured to perform two separate operations. In a first mode of operation, the scoring tool 128 is configured to circumscribe the jacketed wire at a specified distance (d₁) from the end of the jacketed wire. In a second mode of operation, the scoring tool 128 is configured to apply a longitudinal cut to the jacketed wire from the specified distance (d₁) to the end of the jacketed wire. The combination of the circumscribed and longitudinal cuts facilitates the removal of a desired number of layers from the end of the jacketed wire to permit the connection of the jacketed wire to the motor 110 or other component within the pumping system 100. It will be appreciated that these operations may be performed in reverse order, that is, applying the longitudinal cut first, followed by the circumscribed cut second. Thus, references to “first” and “second” in this disclosure are for convenience only and should not be interpreted as a reference to sequence or order of operations, unless specifically disclosed as such.

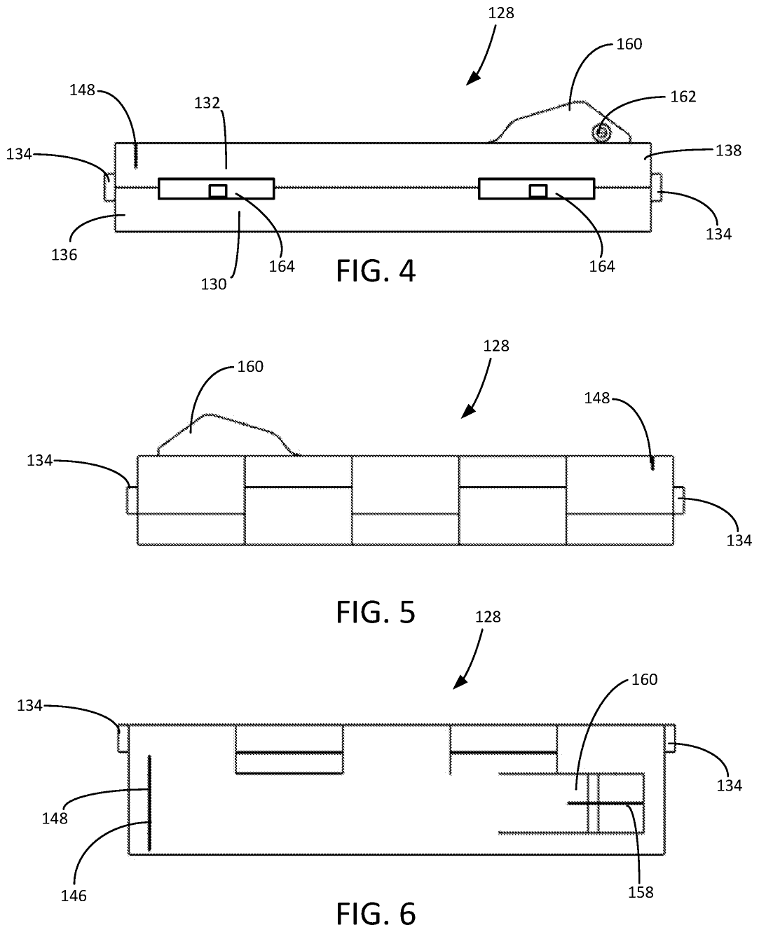

The scoring tool 128 generally has a clam-shell construction, with a base member 130, a top member 132 and one or more hinges 134 that allow the base member 130 and top member 132 to pivot along a longitudinal axis extending through the hinges 134 between an open position (depicted in FIGS. 3 and 9) and a closed position (depicted in FIGS. 4-8). It will be appreciated that the hinges 134 can be made as integrated, unitary portions of the base member 130 and top member 132, or as separate components that are attached to the base member 130 and top member 132. The scoring tool 128 has a first end 136 that is configured to apply the circumscribed cut to the jacketed wire and a second end 138 that is configured to apply the longitudinal cut to the jacketed wire. The scoring tool 128 may include one or more latches 164 (shown in FIG. 4) to secure the scoring tool 128 in a closed position during use.

First end 136 has a lower first receiver recess 140 in the base member 130 and an upper first receiver recess 142 in the top member 132. Each of the lower first receiver recess 140 and upper first receiver recess 142 are tubular, or substantially semi-cylindrical in shape and located in mating positions within the base member 130 and top member 132 such that the lower first receiver recess 140 and upper first receiver recess 142 combined to form a cylindrical first receiver recess 144 when the base member 130 and top member 132 are approximated, such that the first receiver recess 144 is accessible from the first end 136 of the scoring tool 128. The first receiver recess 144 has an interior wall and an exterior opening that is sized and configured to accept the distal end of the jacketed wire.

The scoring tool 128 includes one or more first cutters 146 within the first receiver recess 144. The first cutter 146 is mounted within a first cutter slot 148 that is transversely oriented with respect to the longitudinal axis of the cylindrical first receiver recess 144. The first cutter 146 can be retained within the first cutter slot 148 by a removable fastener 150, such as a bolt or pin. In the embodiment depicted in FIG. 3, the first cutter 146 is mounted within the upper first receiver recess 142 at the distance (d₁) from the interior end of the first receiver recess 144. In other embodiments, the first cutter 146 is mounted in the lower first receiver recess 140. In some embodiments, a first cutter 146 is mounted within both the lower first receiver recess 140 and the upper first receiver recess 142. In each embodiment disclosed herein, the first cutter 146 is mounted within the first receiver recess 144 in a manner that permits an operator to adjust the extent or depth to which the first cutter 146 extends into the first receiver recess 144 to control the depth of the circumscribed cut made to the jacketed wire.

In exemplary embodiments, the first cutter 146 is loaded into the scoring tool 128 by inserting the first cutter 146 into the first cutter slot 148 in the first end 136 of the top member 132 and then locking the first cutter 146 into place with the first cutter fastener 150. The first cutter 146 can be a conventional, commercially available razor blade. The first cutter 146 is designed to be disposable and easily removed from the scoring tool 128 and replaced with a new blade. In some embodiments, the scoring tool 128 includes a plurality of first cutter slots 148 disposed at different distances from the first end 136 so that the position of the first cutter 146 can be longitudinally adjusted to provide for circumscribed cuts at a distance other than (d₁) from the distal end of the jacketed wire.

Like the first end 136, the second end 138 has a lower second receiver recess 152 in the base member 130 and an upper second receiver recess 154 in the top member 132. Each of the lower second receiver recess 152 and upper second receiver recess 154 are tubular, or substantially semi-cylindrical in shape and located in mating positions within the base member 130 and top member 132 such that the lower second receiver recess 152 and upper second receiver recess 154 form a cylindrical second receiver recess 156 that has an interior wall and an exterior opening at the second end 138 of the scoring tool 128. The second receiver recess 156 is sized and configured to accept the distal end of the jacketed wire.

The scoring tool 128 includes a second cutter 158 within the second receiver recess 156. The second cutter 158 is linearly aligned with the longitudinal axis of the cylindrical first receiver recess 144. In the embodiment depicted in FIG. 3, the second cutter 158 is mounted in a second cutter housing 160 within the upper second receiver recess 154 at the distance (d₁) from the interior end of the second receiver recess 156. The second cutter housing 160 may include a second cutter fastener 162 that holds the second cutter 158 in position within the second cutter housing 160. The second cutter 158 can be a conventional razor blade. The second cutter 158 is designed to be disposable and easily removed from the scoring tool 128 and replaced with a new blade.

In other embodiments, the second cutter 158 is mounted in the lower second receiver recess 156. In some embodiments, a plurality of second cutters 146 are mounted within the second receiver recess 156. In each embodiment disclosed herein, the second cutter 158 is mounted within the second receiver recess 156 in a manner that permits an operator to adjust the extent or depth to which the second cutter 158 extends into the second receiver recess 156 to control the depth of the longitudinal cut made to the jacketed wire.

In some embodiments, the scoring tool 128 can be separated into two components: a first part that includes the first end 136 with the first receiver recess 144 and the first cutter 146; and a second part that includes the second end 138 with the second receiver recess 156 and the second cutter 158. In these embodiments, the first and second parts can be connected and disconnected using threaded or latched mechanisms. In yet another embodiment, the scoring tool 128 is provided as a two-part kit in which the first cutter 146 and second cutter 158 are provided as independent units.

An exemplary method of using the scoring tool 128 is described below. The method begins by opening the scoring tool 128 and inserting the distal end of the jacketed wire into the first receiver recess 144 such that the end of the jacketed wire contacts the interior wall of the first receiver recess 144. The scoring tool 128 is then closed such that the first cutter 146 is pressed into the jacketed wire the desired depth and at the distance (d₁) from the end of the jacketed wire. The scoring tool 128 is then rotated around the jacketed wire to perform the circumscribed cut. In an alternate embodiment, a drill or other rotary tool can be affixed to the scoring tool 128 to cause the scoring tool 128 to rotate around the jacketed wire. In some applications, it may be easier to rotate the jacketed wire while maintaining the scoring tool 128 in a fixed position. Once the circumscribed cut has been made to the jacketed wire, the scoring tool 128 can be opened and separated from the jacketed wire.

The same end of the jacketed wire can then be inserted into the second receiver recess 156 of the scoring tool 128 in a position where the distal end of the jacketed wire contacts the interior wall of the second receiver recess 156. The scoring tool 128 can then be closed onto the jacketed wire to press the second cutter 158 into the jacketed wire by the desired depth and at the distance (d₁) from the end of the jacketed wire. Once the scoring tool 128 has been closed, the operator can pull the jacketed wire out of the scoring tool 128 while keeping the scoring tool 128 closed with the second cutter 158 engaged within the jacketed wire at the desired depth. Pulling the jacketed wire out of the scoring tool 128 will cause the second cutter 158 to make a longitudinal cut of (d₁) length to the distal end of the jacketed wire. In exemplary embodiments, the circumscribed and longitudinal cuts will intersect at the desired distance (d₁) from the end of the jacketed wire.

As noted above, in some embodiments it may be desirable to make the longitudinal cut with the second cutter 158 first before making the circumscribed cut with the first cutter 146. In some applications, it may be desirable to make several longitudinal cuts to the jacketed wire by rotating the jacketed wire between several positions within the second receiver recess 156 between subsequent longitudinal cutting operations.

Once the circumscribed and longitudinal cuts have been made, the outer layers of the jacketed wire can be easily removed with pliers or other hand tools. The number of layers removed is determined by the depth of the cuts made by the first and second cutters 146, 158. In this way, the scoring tool 128 provides a mechanism for accurately, precisely and reliably making circumscribed and longitudinal cuts to permit the facilitated removal of one or more outer layers of the jacketed wire. It will be appreciated that the scoring tool 128 is well suited to facilitate the removal of polymer, lead, composite or other insulating and protective layers within the jacketed wire.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A scoring tool for facilitating the removal of one or more outer layers of a multi-layered jacketed wire, the scoring tool comprising:
a first receiver recess on a first end of the scoring tool, wherein the first receiver recess is substantially cylindrical and has an interior wall and an exterior opening;
a first cutter that extends into the first receiver recess at a distance (d₁) from the interior wall of the first receiver recess, wherein the first cutter is transversely oriented within the first receiver recess;
a second receiver recess on a second end of the scoring tool, wherein the second receiver recess is substantially cylindrical and has an interior wall and an exterior opening; and
a second cutter that extends into the second receiver recess at a distance (d₁) from the interior wall of the second receiver recess, wherein the second cutter is longitudinally oriented within the second receiver recess.

2. The scoring tool of claim 1, wherein the first cutter is a razor blade.

3. The scoring tool of claim 1, wherein the second cutter is a razor blade.

4. The scoring tool of claim 1, further comprising a second cutter housing that supports the second cutter.

5. The scoring tool of claim 4, further comprising a second cutter fastener that secures the second cutter in a position within the second cutter housing in which the second cutter extends into the second receiver recess at a desired depth.

6. The scoring tool of claim 1, further comprising a first cutter slot that permits the first cutter to be inserted into the first receiver recess.

7. The scoring tool of claim 6, further comprising a plurality of first cutter slots that each permit the first cutter to be inserted into the first receiver recess at different distances from the interior wall of the first receiver recess.

8. The scoring tool of claim 7, further comprising a first cutter fastener that secures the first cutter in a position in which the first cutter extends into the first receiver recess at a desired depth.

9. The scoring tool of claim 1, wherein the first cutter and the second cutter are secured within the top member.

10. The scoring tool of claim 1, wherein the scoring tool comprises a clam-shell construction that comprises:
a base member;
a top member; and
one or more hinges that connect the base member to the top member.

11. The scoring tool of claim 10, further comprising a latch that releasably holds the base member and top member together while the scoring tool is in a closed position.

12. A method of removing one or more layers surrounding a conductor of a jacketed wire, the method comprising the steps of:
providing a scoring tool that includes a first receiver recess, a first cutter in the first receiver recess, a second receiver recess, and a second cutter in the second receiver recess;
inserting a distal end of the jacketed wire into the first receiver recess such that an end of the jacketed wire contacts an interior wall of the first receiver recess;
closing the scoring tool such that the first cutter is pressed into the jacketed wire at a desired depth and at a distance (d₁) from the end of the jacketed wire; and
inducing a rotation between the scoring tool and the jacketed wire to perform a circumscribed cut at the distance (d₁) from the end of the jacketed wire.

13. The method of claim 12, further comprising the steps of:
opening the scoring tool;
removing the jacketed wire from the first receiver recess;
inserting the end of the jacketed wired into the second receiver recess such that the end of the jacketed wire contacts an interior wall of the second receiver recess;
closing the scoring tool such that the second cutter is pressed into the jacketed wire at a desired depth and at a distance (d₁) from the end of the jacketed wire; and
pulling the jacketed wire out of the second receiver recess to induce a longitudinal cut of (d₁) length to the distal end of the jacketed wire.

14. The method of claim 12, wherein the step of inducing a rotation between the scoring tool and the jacketed wire comprises rotating the scoring tool around the jacketed wire.

15. The method of claim 12, wherein the step of inducing a rotation between the scoring tool and the jacketed wire comprises rotating the jacketed wire within the scoring tool.

16. The method of claim 12, further comprising the step of removing the outer layers of the jacketed wire.

17. A method of removing one or more layers surrounding a conductor of a jacketed wire, the method comprising the steps of:
providing a scoring tool that includes a first receiver recess, a first cutter in the first receiver recess, a second receiver recess, and a second cutter in the second receiver recess;
inserting the end of the jacketed wired into the second receiver recess such that the end of the jacketed wire contacts an interior wall of the second receiver recess;
closing the scoring tool such that the second cutter is pressed into the jacketed wire at a desired depth and at a distance (d₁) from the end of the jacketed wire; and
pulling the jacketed wire out of the second receiver recess to induce a longitudinal cut of (d₁) length to the distal end of the jacketed wire.

18. The method of claim 17, further comprising the steps of:
opening the scoring tool;
removing the jacketed wire from the second receiver recess;
inserting a distal end of the jacketed wire into the first receiver recess such that an end of the jacketed wire contacts an interior wall of the first receiver recess;
closing the scoring tool such that the first cutter is pressed into the jacketed wire at a desired depth and at a distance (d₁) from the end of the jacketed wire; and
inducing a rotation between the scoring tool and the jacketed wire to perform a circumscribed cut at the distance (d₁) from the end of the jacketed wire.

19. The method of claim 18, wherein the step of inducing a rotation between the scoring tool and the jacketed wire comprises rotating the scoring tool around the jacketed wire.

20. The method of claim 18, further comprising the step of removing the outer layers of the jacketed wire.
